(19) United States
(12) Patent Application Publication
(10) Pub. No.: US 2007/0283829 A1
(43) Pub. Date: Dec. 13, 2007

(54) METHOD AND APPARATUS FOR COLLECTING OPERATING DATA FROM MACHINES USED IN THE PRINTING INDUSTRY

(75) Inventors: Matthias Schwarz, Dreieich (DE); Guenter Reimers, Steinburg (DE); Joachim Ruf, Waldkirch (DE); Gregor Enke, Augsburg (DE); Claus Stenger, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/760,620

(22) Filed: Jun. 8, 2007

(30) Foreign Application Priority Data
Jun. 10, 2006 (DE) 10 2006 027 092.4

(51) Int. Cl. B41F 33/00

(52) U.S. Cl. 101/484

(57) ABSTRACT

A method and apparatus for collecting operating data from machines used in the printing industry, in particular from printing presses, is disclosed. At least one machine linked to a control device, or an operating data collection device, automatically transmits data during operation of the machine to the control device, or the operating data collection device, and a time frame for operating data collection is generated automatically from the machine data such that machine activity time intervals about the operating time of the machine on the one hand and machine downtime intervals on the other hand are derived from the machine data. Reasons for downtime are automatically assigned to the established machine downtime intervals and/or can be assigned semi-automatically.

This application claims the priority of German Patent Document No. 10 2006 027 092.4, filed Jun. 10, 2006, the disclosure of which is expressly incorporated by reference herein.

### BACKGROUND AND SUMMARY OF THE INVENTION

The invention relates to a method and apparatus for collecting operating data from machines used in the printing industry, in particular printing presses.

To collect operating data from printing presses and other machines used in the printing industry with comparable environmental conditions to a printing press, the procedure in practice is that when a printing job is being carried out, printing press activity time intervals and printing press downtime intervals are collected manually on an analog daily log. The problem with this is that the operating data collected on the analog day time log are usually incomplete and in addition cannot be checked or verified for accuracy. So in practice it is almost impossible to determine exactly the reasons for printing press downtime intervals in order to draw conclusions from the reasons for these downtimes for subsequent printing jobs and thus ultimately to maximize printing press activity time intervals and minimize printing press downtime intervals.

This also applies to specifications in the form of target values when they are not met in comparison to actual values; reasons can be provided in order to implement the process optimization described above.

No method is known so far from the prior art with the aid of which operating data for printing presses and other machines used in the printing industry can be collected reliably and verifiably for economic and technical analyses.

With this as the starting point, the problem underlying the present invention is to create a novel method and apparatus for collecting operating data for printing presses and other machines used in the printing industry. This problem is solved by a method and apparatus for collecting operating data in accordance with the principles of the present invention.

In accordance with the inventive method and apparatus, while a machine used in the printing industry is operating, in particular a printing press, machine data are automatically transmitted to a control device, or to an operating data collection device, where a time framework for operating data collection is automatically generated from the machine data such that firstly printing press activity time intervals and secondly printing press downtime intervals are derived from the machine data concerning printing press operating time and such that reasons are automatically assigned to the printing press downtime intervals determined and/or can be assigned semi-automatically.

This applies also at a specific production time point for the comparison between target and actual data to which a reason can be assigned in the event of non-achievement in the positive or negative sense.

Within the meaning of the present invention, machine data-assisted operating data collection from the machines used in the printing industry, in particular printing presses, is provided with the aid of which operating data can be collected reliably and verifiably. From the machine data transmitted from a printing press to the control device, or operating data collecting device, a time framework for operating data collection is generated, where reasons are assigned automatically or semi-automatically to the printing press downtime intervals of the time framework. The semi-automatic assignment of the reasons for downtime is menu-guided so that a plausibility check takes place automatically. The possibility of erroneous entries and manipulation during operating data collection is considerably reduced compared with the analog day logs known from practice. Furthermore, through verifiable operating data collection, reasons for downtimes can be analyzed such that in subsequent printing jobs printing press downtimes are minimized in order ultimately to increase the working capacity and effectiveness of a printing press.

Preparatory operations of all kinds, even operations on non-involved components, can be entered in parallel to the collection of operating data on a current print job.

Preferred refinements of the invention can be found in the description hereinafter. Embodiments of the invention, without being limited thereto, are explained in more detail using the drawings.

### BRIEF DESCRIPTION OF THE DRAWINGS

FIG. 1 shows a diagram to clarify the method in accordance with the invention for collecting operating data from printing presses;

FIG. 2 shows a further diagram to clarify the method in accordance with the invention;

FIG. 3 shows a further diagram to clarify the method in accordance with the invention; and

FIG. 4 shows a further diagram to clarify the method in accordance with the invention.

### DETAILED DESCRIPTION OF THE DRAWINGS

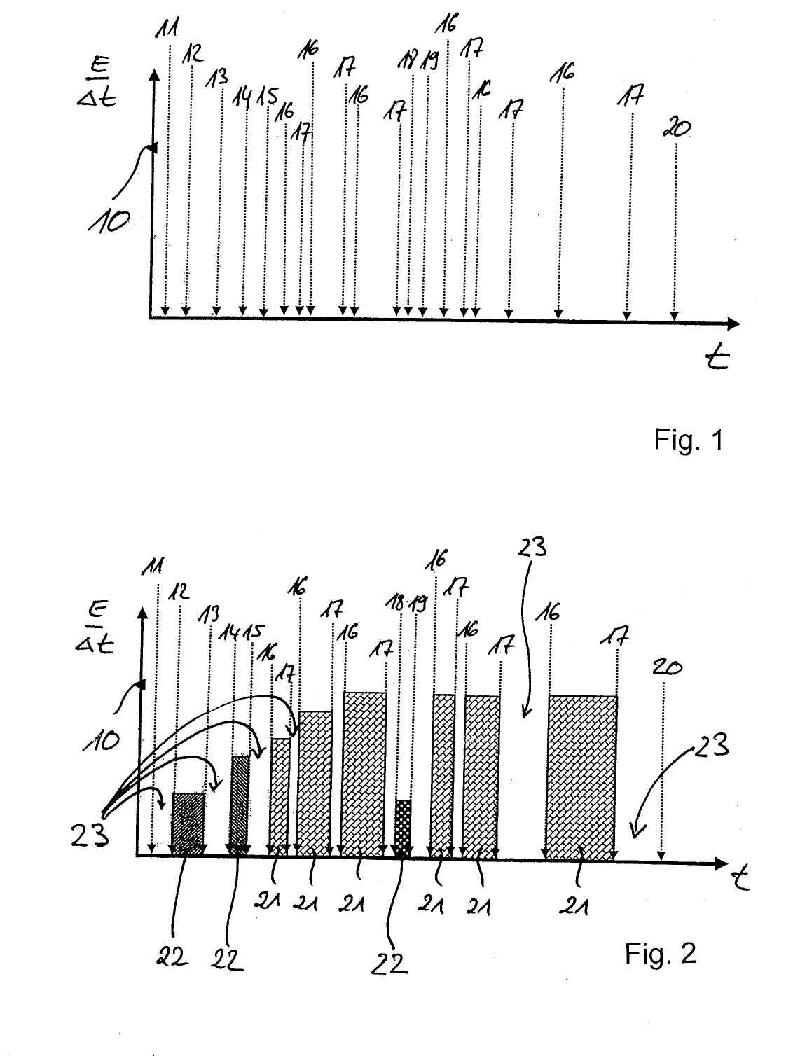

The present invention relates to a method and apparatus for collecting operating data from printing presses which will be described hereinafter in greater detail with reference to FIGS. 1 to 4. For the purpose of a simpler presentation of the invention, it will be assumed in what follows that only a single printing press transmits machine data, including production data, automatically to a control device coupled with the printing press which acts as an operating data collection device. It is self-evident that the method in accordance with the invention can also be used when several printing presses are coupled to an operating data collection device and transmit corresponding machine data to the device.

In the diagram from FIG. 1 the operating time t of a printing press is entered on the horizontal axis and the number of printed copies E per time unit Δt is entered on the vertical axis. A pointer 10 shown on the vertical axis corresponds to the number of copies E/Δt printed in the print run per time unit.

As can be seen from FIG. 1, the printing press automatically transmits a plurality of machine data 11, 12, 13, 14, 15, 16, 17, 18, 19 and 20 during its operating time t to the control device linked to the printing press which acts as an operating data collection device. In the embodiment shown, machine datum 11 concerns the loading of a print job to be performed on the printing press. In the case of machine datum 12, it is the start of a printing plate change and in the case of machine datum 13, the end of a printing plate change.

Machine datum 14 concerns the start of a macule print and machine datum 15 the end of a macule print. In the case of machine datum 16, it is the start of a print run and in the case of machine datum 17 the stop of a print run. In the case of machine datum 18, it is the start of a wash and in the case of machine datum 19 the end of a wash. In the case of machine datum 20, it signals the end of the print job, or deactivation of the printing press.

A time framework for operating data collection is generated automatically from the machine data 11 to 20 transmitted automatically from the printing press to the operating data collection device, where this time framework comprises printing press activity time intervals and also printing press shutdown time intervals. Printing press activity time intervals are understood to mean such time intervals 21 for operating time t in which usable print copies, known as clean copies, are printed. Printing press activity time intervals correspond, therefore, to a print run operating condition of the printing press. All other time intervals from operating time t should be regarded as printing press downtime intervals. Printing press downtime intervals include a time interval which can be identified between machine datum 20 and a further machine datum 11.

Based on the machine data 11 to 20 transmitted from the printing press, reasons for downtime can be automatically assigned to initial printing press downtime intervals 22. In the embodiment shown, these first printing press downtime intervals 22 relate to the time intervals between machine data 12 and 13, 14 and 15 and 18 and 19, where these machine data contain the reasons for the respective first printing press downtime intervals 22. Thus, it follows automatically from machine data 12 and 13 that in the case of printing press downtime interval 22 between machine data 12 and 13 it is a plate change time interval. From machine data 18 and 19 it follows automatically that in the case of the printing press downtime interval 22 lying between this data it is a wash interval.

In the case of all remaining time intervals for operating time t which are neither printing press activity time intervals 21 nor first printing press downtime intervals 22, it concerns second printing press downtime time intervals 23 which are undefined with regard to the reason for the downtime. It is therefore within the meaning of the present invention to assign reasons semi-automatically for the downtime to these second printing press downtime intervals 23 which are undefined regarding the reason for the downtime.

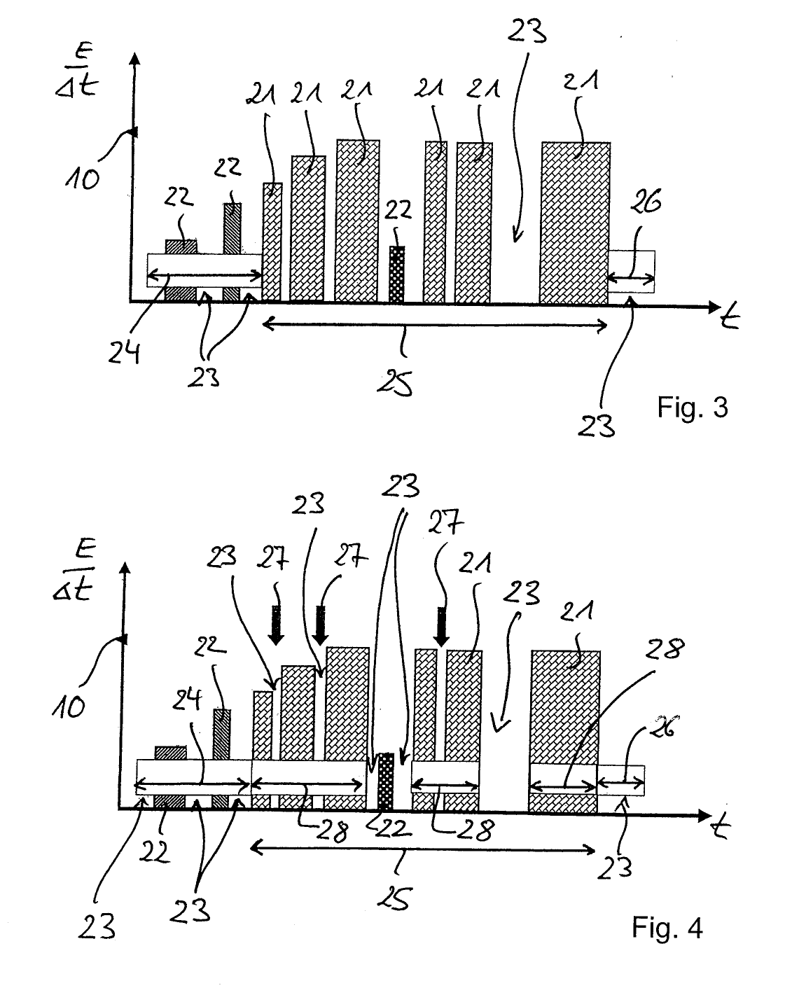

After generating the printing press activity time intervals 21 and the printing press downtime intervals 22 and 23 from the machine data 11 to 20 transmitted from the printing press, in accordance with FIG. 3 the operating time of the printing press between machine data 11 and 20 is automatically subdivided into a set-up phase 24, a print run phase 25 and a shut-down phase 26. The set-up phase 24 is defined as the period which lies between loading the job onto the printing press in accordance with machine datum 11 and the printing of a clean copy in accordance with the earliest appearing machine datum 16. The print run phase 25 corresponds to the period which lies between the printing of the first clean sheet in accordance with the earliest occurring machine datum 16 and when the desired print edition is reached at the last occurring machine datum 17, alternatively between the last occurring machine datum 17 or the last machine downtime before machine datum 20, depending on which event occurred first. The shut-down phase 26 follows on after this until machine datum 20 is reached.

Within the print run phase 25, the second printing press downtime intervals 23, undefined with respect to the reason, which are less, or alternatively shorter, than a freely definable period are evaluated as printing press activity time intervals and assigned accordingly to the printing press activity time intervals 21. In the embodiment shown these are the printing press downtime intervals 23 identified in FIG. 4 with the arrows 27.

Expanded printing press activity time intervals 28 are accordingly derived from the printing press activity time intervals 21 and those undefined second printing press downtime intervals 23 which are less, or shorter, than the definable period. Those printing press downtime intervals 23, undefined as to the reason, which on the other hand are greater, or longer, than the definable period continue to be regarded as second printing press downtime intervals 23.

Subsequently an appropriate reason for downtime can be assigned semi-automatically or menu-guided to the second printing press downtime intervals 23 which are undefined with respect to the reason. For this, appropriate operating phase-specific reasons for downtime for the specific printing press downtime intervals 23 are automatically offered to an operator which can be assigned by the operator to the appropriate printing press downtime intervals 23.

For the set-up phase 24, a printing press downtime, undefined with respect to the reason, is determined for the set-up phase 24 from a total period for the set-up phase 24 and the first printing press downtime intervals 22 automatically defined regarding the reason for downtime, where set-up phase-specific downtime reasons can be assigned semi-automatically and menu-guided to this undefined printing press downtime time period 24, to which no downtime reasons are assigned automatically. These set-up phase-specific reasons for downtime are, for example, events such as basic adjustments and/or a color change and/or a maintenance phase. Consequently, only those reasons for downtime which are specific to the set-up phase are automatically offered to that printing press downtime of the set-up phase 24 to which no reason for downtime is assigned automatically. An operator can only select one or more reasons for downtime from these set-up phase-specific downtime reasons in order to define the still undefined printing press downtime with respect to the reason.

For the printing press downtime intervals 23 of the production run phase 25 which are still undefined with respect to the reason for the downtime and which because of their size, or length, are not evaluated as printing press activity intervals, reasons for downtime can be similarly assigned semi-automatically, where print run phase-specific reasons for downtime are offered automatically for the printing press downtime time intervals 23 which can then be assigned by the operator to the specific printing press downtime intervals 23. In the case of such print run phase-specific reasons for downtime, they are, for example, technical problems in the production run such as a substrate backup or a substrate crack.

For the shut-down phase 26, in the same way as for the set-up phase 24, a printing press downtime, undefined with respect to the reason, is determined to which downtime reasons can be assigned semi-automatically and menu-guided by automatically offering shut-down phase-specific reasons for downtime which can then be assigned by the operator to the specific downtime.

In the sense of the present invention, readings from print copy counters are transmitted automatically from the printing press to the operating data collection device during the print run phase as additional machine data in order to generate, or to determine, a macule copy counter reading automatically. In the meaning of the present invention, reasons for the macules can be assigned automatically or semi-automatically to the macule counter reading, in a similar way to the printing press downtime time intervals. In this way, it is possible for the first time to determine the number of macule copies actually printed exactly and free of manipulation and to assign reasons to the macules. As a result, the traceability and transparency of printing press operations is increased.

It is furthermore possible to transmit a reset signal from a clean sheet counter automatically from the printing press to the operating data collection device during the print run phase as an additional machine signal. Then, when this type of reset signal is transmitted, the time period of the print run phase accumulated before the reset signal is automatically assigned to the set-up phase and only the time period immediately following the reset signal is defined as a print run phase. The assignment of reasons for downtime to second printing press downtime intervals 23, undefined with respect to the reason for the downtime, is performed as described above.

### REFERENCE NUMBER LIST

10 Pointer
11 Machine datum
12 Machine datum
13 Machine datum
14 Machine datum
15 Machine datum
16 Machine datum
17 Machine datum
18 Machine datum
19 Machine datum
20 Machine datum
21 Printing press activity time interval
22 Printing press downtime interval
23 Printing press downtime interval
24 Set-up phase
25 Print run phase
26 Shutdown phase
27 Arrow
28 Expanded printing press activity interval

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for collecting operating data from machines used in a printing industry, in particular from printing presses, where at least one machine, in particular a printing press, used in the printing industry linked to a control device, or operating data collection device, during operation of the machine automatically transmits machine data to the control device, or the operating data collection device, and where a time frame for operating data collection is automatically generated from the machine data such that from the machine data for the operating time of the machine used in the printing industry, in particular of a printing press, on the one hand machine activity time intervals and on the other hand machine downtime intervals are derived automatically, and such that reasons are assigned automatically to the machine downtime intervals determined in a form of economic and/or technical information and/or are assigned semi-automatically.

2. The method according to claim 1, wherein when the transmitted machine data for specific, initial machine downtime intervals contain reasons for the downtime, the reasons are automatically assigned to the specific initial machine downtime intervals.

3. The method according to claim 3, wherein when the transmitted machine data for specific, second machine downtime intervals do not contain reasons for the downtime, operating phase-specific reasons for the downtime are assigned semi-automatically to the particular second machine downtime time intervals, where appropriate operating phase-specific reasons for downtime are offered to an operator for the specific second machine downtime intervals which are then assigned by the operator to the particular second machine downtime intervals.

4. The method according to claim 1, wherein a period between loading a print job onto the printing press and printing a first clean copy is automatically defined as a set-up phase, a period between the printing of the first clean copy and reaching a specified production run number is automatically defined as a print run phase, and a period between reaching the specified production run number and loading a subsequent print job or deactivating the printing press is defined automatically as a shut-down phase.

5. The method according to claim 4, wherein a printing press downtime, undefined with respect to its downtime, is determined for a period between unloading a print job on the printing press and loading a further print job and wherein the undefined printing press downtime is identified as unused machine time.

6. The method according to claim 1, wherein a printing press downtime undefined with respect to a reason is determined for a set-up phase from a total duration for the set-up phase and defined printing press downtime intervals of the set-up phase.

7. The method according to claim 6, wherein set-up phase-specific reasons are assigned semi-automatically and menu-guided to the undefined printing press downtime for the set-up phase.

8. The method according to claim 1, wherein in a print run phase, printing press downtime intervals which are shorter than a definable period, are evaluated as printing press activity time intervals such that downtime reasons are assigned only to such printing press downtime intervals of the print run phase which are greater than the definable period.

9. The method according to claim 8, wherein print run-specific-reasons for downtime are assigned semi-automatically and menu-guided to the printing press downtime time intervals for the print run phase.

10. The method according to claim 1, wherein during a print run phase, counter readings from print copy counters are automatically transmitted as machine data in order to determine automatically a maculate copy counter reading where reasons for the maculates are assigned to the maculate copy counter reading.

11. The method according to claim 1, wherein for a shutdown phase, a printing press downtime, undefined with respect to a reason, is established, and wherein a reason is assigned semi-automatically and menu-guided to the undefined printing press downtime.

12. The method according to claim 1, wherein in a print run phase, a reset signal for a clean sheet counter is transmitted as a machine datum, wherein, when the reset signal is transmitted, a time period of the print run accumulated before the reset signal is automatically assigned to a set-up phase and only the period following the reset signal is automatically defined as the print run phase.

13. A method for collecting operating data from a printing press, comprising the steps of:
automatically transmitting machine data from the printing press to an operating data collection device during operation of the printing press;
deriving a printing press activity time interval and a printing press downtime time interval from the machine data by the operating data collection device; and
determining a reason for the printing press downtime time interval by considering the machine data.

14. The method according to claim 13, wherein the reason is determined automatically and wherein the reason is contained in the machine data.

15. The method according to claim 13, wherein the reason is determined semi-automatically by an operator of the printing press and wherein the reason is not contained in the machine data.

16. The method according to claim 15, wherein the step of semi-automatically determining the reason by the operator includes the steps of providing a plurality of reason options to the operator and determining the reason by the operator from the plurality of reason options.

17. The method according to claim 16, wherein the plurality of reason options are associated with an operating phase of the printing press in which the printing press downtime time interval occurred.

18. The method according to claim 17, wherein the operating phase is one of a set-up phase, a print run phase, and a shut-down phase.

19. An apparatus for collecting operating data from a printing press, comprising:
a printing press; and
an operating data collection device coupled to the printing press;
wherein the printing press automatically transmits machine data from the printing press to the operating data collection device during operation of the printing press;
wherein a printing press activity time interval and a printing press downtime time interval is automatically derived from the machine data by the operating data collection device;
and wherein a reason is determined for the printing press downtime time interval by considering the machine data.

20. The apparatus according to claim 19, wherein the reason is determined automatically and wherein the reason is contained in the machine data.
